(19) United States
(12) Patent Application Publication
(10) Pub. No.: US 2018/0234566 A1
(43) Pub. Date: Aug. 16, 2018

(54) SHEET CARRYING GUIDE

(71) Applicants: KABUSHIKI KAISHA TOSHIBA, Tokyo (JP); TOSHIBA TEC KABUSHIKI KAISHA, Tokyo (JP)

(72) Inventor: Keigo Okasaka, Mishima Shizuoka (JP)

(21) Appl. No.: 15/467,078

(22) Filed: Mar. 23, 2017

(30) Foreign Application Priority Data
Feb. 10, 2017 (JP) 2017-023523

(51) Int. Cl. H04N 1/00; B65H 29/70

(52) U.S. Cl. CPC H04N 1/00615; B65H 29/70; H04N 2201/0081; B65H 2801/39; H04N 1/00588

(57) ABSTRACT

According to one embodiment, a sheet carrying guide includes a first guide and a second guide. The first guide guides a sheet carried in a sub-scanning direction orthogonal to a main-scanning direction corresponding to a reading unit configured to read an image. The second guide faces the first guide and guides carrying of the sheet. In the sheet carrying guide of the embodiment, facing distance between the first guide and the second guide in both end portions of the main-scanning direction is narrower than facing distance between the first guide and the second guide in center portion thereof in the main-scanning direction.

### CROSS-REFERENCE TO RELATED APPLICATION

This application is based upon and claims the benefit of priority from Japanese Patent Application No. 2017-023523, filed Feb. 10, 2017, the entire contents of which are incorporated herein by reference.

### FIELD

Embodiments described herein relate generally to a sheet carrying guide.

### BACKGROUND

There is a document reading device that reads an image from an original document while carrying the original document.

In such a document reading device, there is a problem that a shift in the read image by floating of the original document is generated.

### DESCRIPTION OF THE DRAWINGS

FIG. 1 is a schematic view illustrating an internal structure of an image reading system according to an embodiment.

FIG. 2 is a schematic side view illustrating a back surface carrying guide and a periphery thereof according to a first embodiment.

FIG. 3 is a perspective view illustrating the back surface carrying guide according to the first embodiment.

FIG. 4 is a schematic cross-sectional view of the back surface carrying guide according to the first embodiment.

FIG. 5 is a schematic side view illustrating a surface carrying guide and the periphery thereof according to the first embodiment.

FIG. 6 is a schematic cross-sectional view of the surface carrying guide according to the first embodiment.

FIG. 7 is a perspective view illustrating a back surface carrying guide according to a second embodiment.

FIG. 8 is a schematic cross-sectional view of the back surface carrying guide according to the second embodiment.

FIG. 9 is a perspective view illustrating a back surface carrying guide according to a third embodiment.

FIG. 10 is a schematic cross-sectional view of the back surface carrying guide according to the third embodiment.

FIG. 11 is a schematic cross-sectional view of a back surface carrying guide according to a modification example of the embodiment.

FIG. 12 is a schematic side view illustrating a back surface carrying guide and a periphery thereof according to a modification example of the embodiment.

FIG. 13 is a schematic side view illustrating a back surface carrying guide and a periphery thereof according to a modification example of the embodiment.

FIG. 14 is a schematic side view illustrating a back surface carrying guide and a periphery thereof according to a modification example of the embodiment.

FIG. 15 is a schematic cross-sectional view illustrating an example of a document reading device of the related art.

FIG. 16 is a view illustrating a shift in a read image when an original document floats.

FIG. 17 is a view illustrating an example of a lens, a CCD sensor, and a document surface in the document reading device of the related art.

### DETAILED DESCRIPTION

In order to solve the above problem, it is conceivable to narrow distance between a carrying guide and a reading glass so that an original document is hardly separated from the reading glass. However, when the distance is narrowed, carrying resistance increases. As the carrying resistance increases, force necessary for carrying the original document increases. In other words, motor torque necessary for carrying the original document increases.

An object to be solved by an exemplary embodiment is to provide a sheet carrying guide that reduces a shift in a read image while suppressing an increase in the carrying resistance.

In general, according to one embodiment, the sheet carrying guide includes a first guide and a second guide. The first guide guides a sheet carried in a sub-scanning direction orthogonal to a main-scanning direction corresponding to a reading unit configured to read an image. The second guide faces the first guide and guides carrying of the sheet. In the sheet carrying guide of the embodiment, facing distance between the first guide and the second guide in both end portions of the main-scanning direction is narrower than facing distance between the first guide and the second guide in center portion thereof in the main-scanning direction.

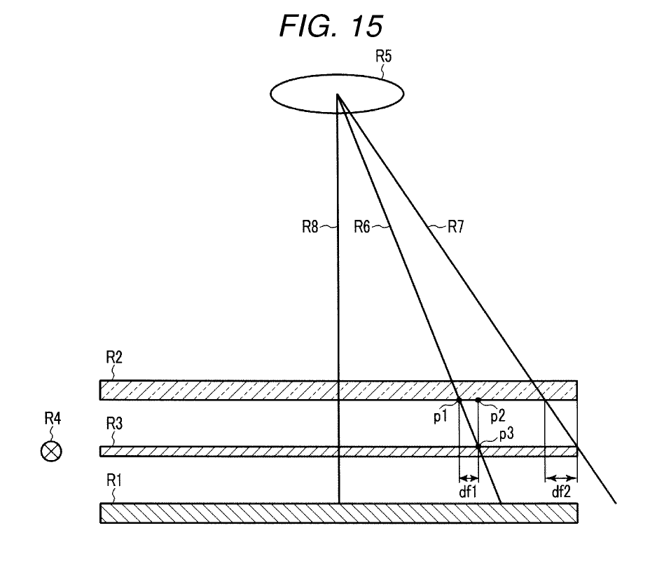

FIG. 15 is a schematic cross-sectional view illustrating an example of a document reading portion of a document reading device of the related art. An original document R3 is carried between a carrying guide R1 and a reading glass R2 in a carrying direction R4, that is, herein, in a direction from a front of a page surface toward a back of the page surface. An image of an upper surface of the carried original document R3 is read through the lens R5. Preferably, the image of the original document R3 is read in a state where the original document R3 is in contact with the reading glass R2. However, as illustrated in FIG. 15, when the original document R3 is at a position separated from the reading glass R2, the read image is shifted from the correct position.

A straight line R6 passing through the lens R5 passes through a point p1 on the reading glass R2 and a point p3 on the original document R3. As can be seen from this, as viewed from the lens R5, the point p3 on the original document R3 appears to be at the point p1 on the reading glass R2. However, when the original document R3 is in contact with the reading glass R2, the point p3 will be at a position of the point p2. Therefore, the read image is shifted inside in the main-scanning direction by df1. The main-scanning direction herein is a direction parallel to a straight line p1p2. Likewise, at an outside end portion of the original document R3, the read image is shifted inside in the main-scanning direction by df2. df2 is larger than df1. As can be seen from the fact that a straight line R8 passes through a center of the reading glass R2 and a center of the original document R3, at the center portion, a shift of the read image caused by the floating of the original document R3 is hardly generated. As described above, the shift of the read image by the floating of the original document R3 becomes larger toward an outside of the original document R3 and the shift becomes substantially 0 at the center thereof.

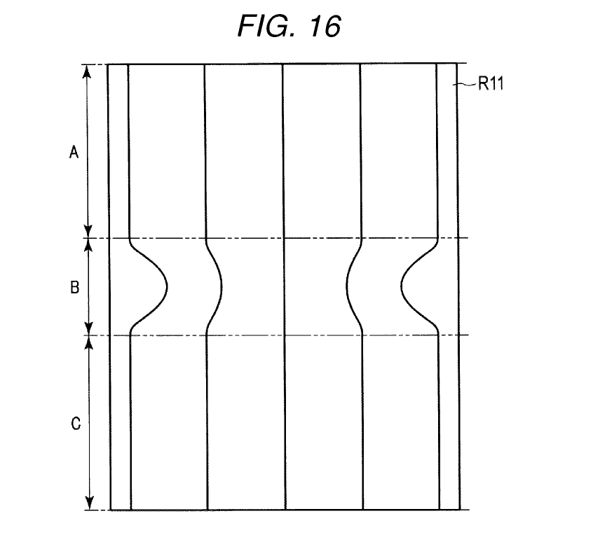

FIG. 16 is a view illustrating the shift in the read image when the original document floats. Five vertical lines parallel to the carrying direction R4 are drawn on a surface of the original document R3 to be read. The original document R3 is first read in a state of being in contact with the reading glass R2, is read primarily in a state of being separated from the reading glass R2, and then is read again in a state of being in contact with the reading glass R2. The read image R11 is illustrated assuming an image read from the original document R3 under the situation described above. Section A and section C are those which are read while the original document is in contact with the reading glass R2. Section B is one which is read when the original document R3 is separated from the reading glass R2. In section A and section C, since the image of the original document R3 is considered to be read correctly, five vertical straight lines appear. On the other hand, in section B, the straight line shifts inside. In other words, if the original document R3 floats, the read image shrinks inside.

The size of the shift is calculated assuming the embodiment described below.

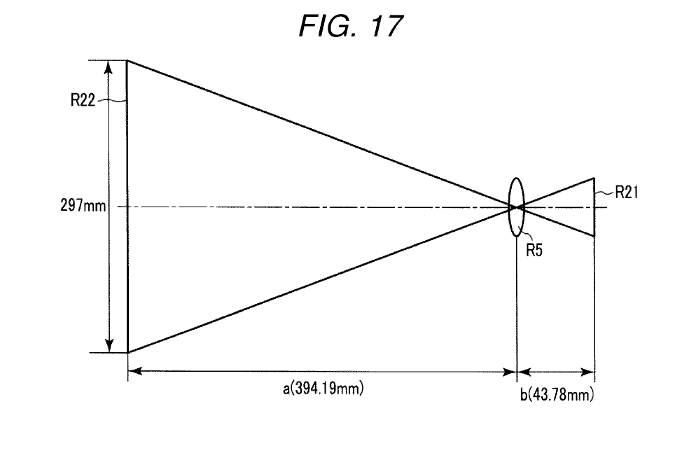

FIG. 17 is a view illustrating a lens R5, a CCD sensor image surface R21 and a document surface R22 in the embodiment.

A front side optical path length a is 394.19 mm and a rear side optical path length is 43.78 mm. Therefore, the magnification b/a is 0.111063 times. In addition, a width of the document surface R22 is 297 mm. 297 mm corresponds to a length of an A4 long side or an A3 short side. In the above case, if a shrinkage amount df [mm] for each width in the main-scanning direction is calculated assuming when the original document floats 1 mm, the results are illustrated in Table 1. The width in the main-scanning direction is equal to a distance from the center of the original document. For example, an edge of the original document having a width of 297 mm corresponds to a width of 148.5 mm in the main-scanning direction. Therefore, a width of 150 mm in the main-scanning direction indicates an outside of the original document. In other words, the shrinkage amount for the width of 150 mm in the main-scanning direction is calculated as a reference.

TABLE 1
When original document floats 1 mm

| | width of main-scanning | shrinkage amount |
|---|---|---|
| position | direction [mm] | (df[mm]) |
| center of original | 0 | 0 |
| document | 10 | −0.0253 |
| | 20 | −0.05061 |
| | 30 | −0.07591 |
| | 40 | −0.10122 |
| | 50 | −0.12652 |
| | 60 | −0.15183 |
| | 70 | −0.17713 |
| | 80 | −0.20243 |
| | 90 | −0.22774 |
| | 100 | −0.25304 |
| | 110 | −0.27835 |
| | 120 | −0.30365 |
| | 130 | −0.32896 |
| | 140 | −0.35426 |
| periphery of | 150 | −0.37956 |
| original document | | |

According to Table 1, it can be confirmed that the amount of shrinkage gradually increases toward the outside of the original document.

Hereinafter, an image reading system according to some embodiments will be described with reference to the drawings. In each drawing in the present specification, in order to make each member easy to recognize, scale of each member may be appropriately changed in some cases.

### First Embodiment

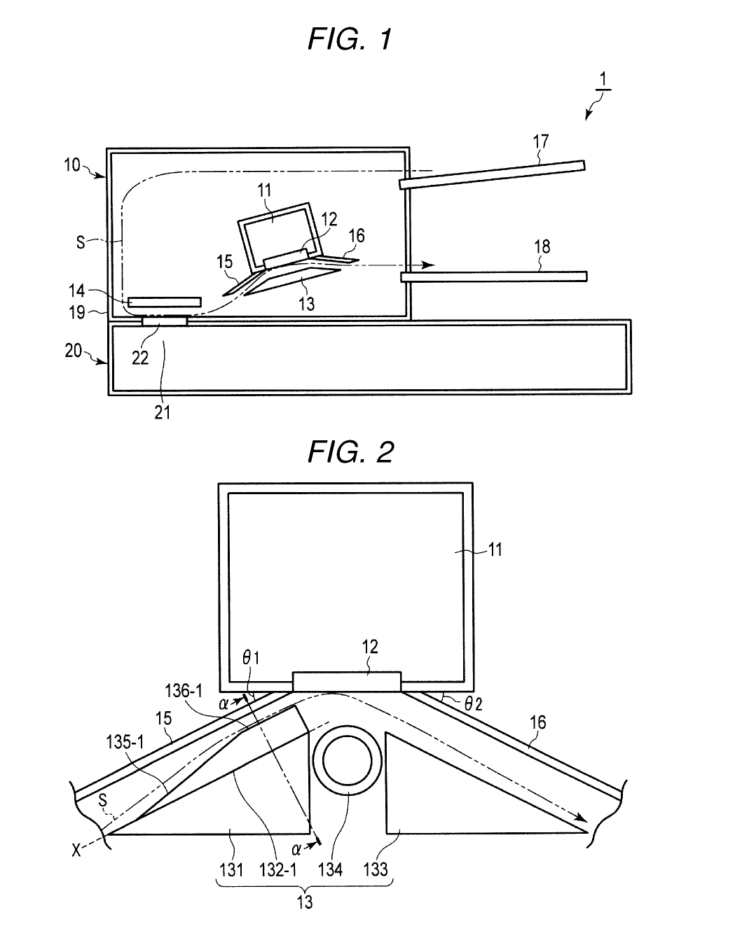

FIG. 1 is a schematic view illustrating an internal structure of an image reading system 1 according to a first embodiment.

The image reading system 1 introduces an original document placed on a document tray 17 into a housing 19. The image reading system 1 can read image from both surfaces of the original document by sequentially reading one surface of a surface or a back surface of the original document on each of the two optical units while carrying the original document introduced into the housing 19. Alternatively, the image reading system 1 can read an image from one surface of the original document by reading an image of the surface or the back surface of the original document in one of the two optical units. The original document is a sheet-like member such as paper. In addition, in the original document, a side surface far from the document tray 17, that is, an upper surface is referred to as a surface and a side surface close to the document tray 17, that is, a lower surface is referred to as a back surface, when the original document is placed on the document tray 17. The image reading system 1 includes a document carrying device 10 and an image reading device 20. The image reading system 1 is an example of a document reading device.

The document carrying device 10 introduces the original document placed on the document tray 17 into the housing 19 and also carries the original document. Further, the document carrying device 10 reads an image from the back side of the original document. The document carrying device 10 is an auto document feeder (ADF), for example. The document carrying device 10 includes a back surface optical unit 11, a back surface reading glass 12, a back surface carrying guide 13, a surface carrying guide 14, an upstream-side upper guide 15, a downstream-side upper guide 16, the document tray 17, a paper discharge tray 18, and a housing 19.

The back surface optical unit 11 includes an imaging element and a lens for reading an image from the back surface of the original document. The imaging element is a charge-coupled device (CCD) image sensor or a complementary metal-oxide-semiconductor (CMOS) image sensor, for example. The imaging element forms a line sensor as an example. At this time, a direction in which the imaging elements are aligned is referred to as the main-scanning direction. In addition, a direction perpendicular to the main-scanning direction on a reading surface from which an image is read is referred to as the sub-scanning direction. The original document is carried in the sub-scanning direction. The back surface optical unit 11 is an example of a reading unit that reads an image from the original document.

The back surface reading glass 12 is a transparent member. A lower side of the back surface reading glass 12 is a place where an image of an original document is read. The back surface optical unit 11 reads an image from the back surface of the original document passed over the surface of the back surface reading glass 12 through the back surface reading glass 12. The document carrying device 10 may be provided with a transparent resin, compound, or the like in place of the back surface reading glass 12. A lower surface of the back surface reading glass 12 is an example of a reading surface. In addition, the reading surface is provided as an example of a second virtual plane.

The back surface carrying guide 13 is provided in order to guide carrying of the original document and guide the original document so that the original document is in contact with the back surface reading glass 12. The details of the back surface carrying guide 13 will be described below.

The back surface carrying guide 13 is an example of a first guide. In addition, the back surface carrying guide 13 is an example of a third guide.

The surface carrying guide 14 is provided in order to guide the carrying of the original document and introduce the original document so that the original document is in contact with the surface reading glass 22. Details of the surface carrying guide 14 will be described below.

The upstream-side upper guide 15 is provided to guide the carrying of the original document and guide the original document onto the back surface reading glass 12. The upstream-side upper guide 15 forms an angle of θ1 with the back surface reading glass 12. The upstream-side upper guide 15 faces the back surface carrying guide 13. A carrying path through which the original document is carried is formed by the back surface carrying guide 13 and the upstream-side upper guide 15. The carrying path is obliquely oriented with respect to the back surface reading glass 12 and forms an angle of θ1 with the back surface reading glass 12. The carrying path includes an example of a first virtual plane.

The upstream-side upper guide 15 is an example of a second guide.

The downstream-side upper guide 16 is provided in order to guide the carrying of the original document and guide the original document passed over the back surface reading glass 12 to a next carrying destination. The downstream-side upper guide 16 forms an angle 82 with the back surface reading glass 12. The downstream-side upper guide 16 faces the back surface carrying guide 13. A carrying path through which the original document is carried is formed by the back surface carrying guide 13 and the downstream-side upper guide 16. The carrying path is obliquely oriented with respect to the back surface reading glass 12 and forms an angle of θ2 with the back surface reading glass 12. The downstream-side upper guide 16 is an example of a fourth guide.

The document tray 17 is a table on which the original document to be read by the image reading system 1 is placed. An operator of the image reading system 1 places the original document to be read on the document tray 17. The operator may superimpose a plurality of original documents on the document tray 17. The document carrying device 10 introduces the original documents placed on the document tray 17 one by one into the housing 19. The introduction into the housing 19 is performed by a roller (not illustrated) or the like.

The paper discharge tray 18 is a table on which the original document discharged from an inside of the housing 19 of the document carrying device 10 after an image thereon is read by the image reading system 1 is placed.

The image reading device 20 reads an image from the surface of the original document. The image reading device 20 includes a surface optical unit 21 and a surface reading glass 22.

The surface optical unit 21 includes an imaging element and a lens for reading an image from the surface of the original document. The imaging element is a CCD image sensor, or a CMOS image sensor, for example. The imaging element forms a line sensor as an example. At this time, a direction in which the imaging elements are aligned is referred to as the main-scanning direction. In addition, a direction perpendicular to the main-scanning direction on a reading surface from which an image is read is referred to as the sub-scanning direction. The original document is carried in the sub-scanning direction. The surface optical unit 21 is an example of a reading unit that reads an image from the original document.

The surface reading glass 22 is a transparent member. The upper side of the back surface reading glass 12 is a place where an image of an original document is read. The surface optical unit 21 reads an image from the surface of the original document passed over the surface of the surface reading glass 22 through the surface reading glass 22. The image reading device 20 may be provided with a transparent resin, compound, or the like in place of the surface reading glass 22. The upper surface of the surface reading glass 22 is an example of a reading surface.

A carrying route S indicates an example of a route along which the original document is carried. The original document passes through the carrying route S by being guided by the back surface carrying guide 13, the surface carrying guide 14, the upstream-side upper guide 15, the downstream-side upper guide 16, a guide (not illustrated), and a roller (not illustrated).

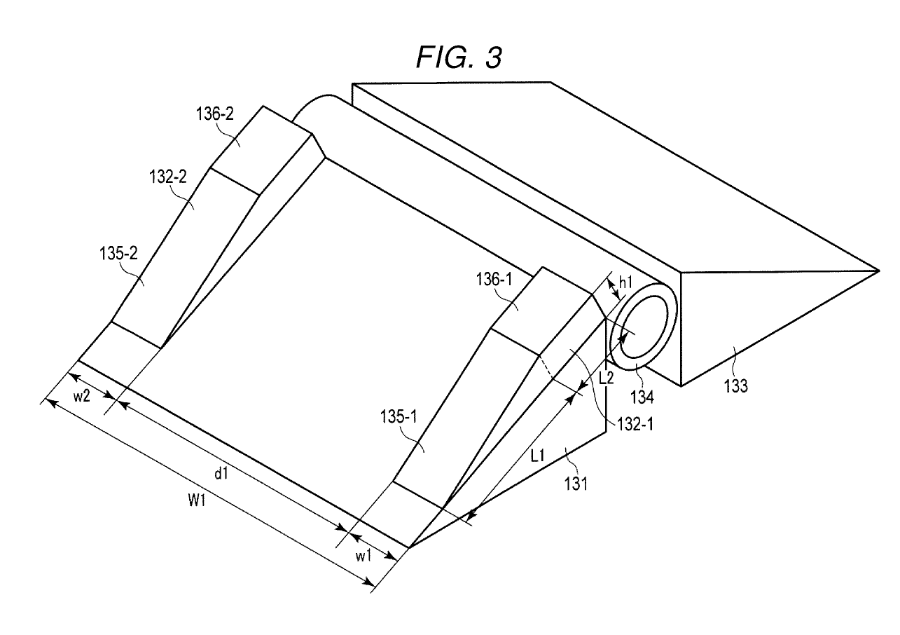

Hereinafter, the back surface carrying guide 13 will be described in more detail with reference to FIG. 2 to FIG. 4.

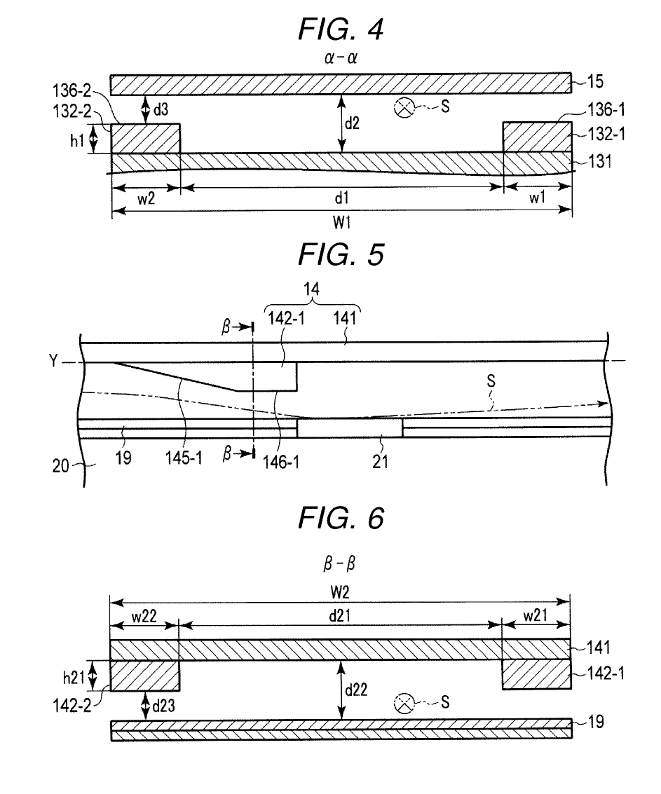

FIG. 2 is a schematic side view illustrating the back surface carrying guide 13 and a periphery thereof. However, FIG. 2 is a view illustrating a portion of FIG. 1 which is rotated so that the back surface reading glass 12 is horizontal. FIG. 3 is a perspective view illustrating the back surface carrying guide 13. FIG. 4 is a schematic cross-sectional view taken along line α-α illustrating the back surface carrying guide 13 and the periphery thereof.

As illustrated in FIG. 2 to FIG. 4, the back surface carrying guide 13 includes an upstream-side guide 131, a back surface convex portion 132-1, a back surface convex portion 132-2, a downstream-side guide 133, and a shading roller 134.

The upstream-side guide 131 is provided in order to guide the carrying of the original document and guide the original document onto the back surface reading glass 12. The upstream-side guide 131 includes a slope surface X parallel to the upstream-side upper guide 15. In the description of the back surface carrying guide, a direction parallel to the slope surface X and perpendicular to the carrying direction is defined as the main-scanning direction. The carrying direction coincides with the sub-scanning direction. The upstream-side guide 131 has a length of a width W1 in the main-scanning direction. The width W1 is 297 mm, as an example. 297 mm corresponds to the length of an A3 short side or an A4 long side. Therefore, if the width W1 is 297 mm or more, the original document up to A3 can pass through the carrying path. The width W1 may be a value corresponding to the size of the original document to correspond and is not limited to 297 mm. In addition, a margin may be given to the size of the original document. Facing distance between the upstream-side guide 131 and the upstream-side upper guide 15 is d2.

The back surface convex portion 132-1 and the back surface convex portion 132-2 is provided so that an interval between the carrying paths formed by the back surface carrying guide 13 and the upstream-side upper guide 15 is narrower on an outside thereof than on the inside thereof in the main-scanning direction. A portion of the back surface carrying guide 13 that is closer to the upstream-side upper guide 15 than the slope surface X is referred to as a back surface convex portion. The back surface convex portion 132-1 and the back surface convex portion 132-2 include the following shapes to be described below as an example.

The back surface convex portion 132-1 and the back surface convex portion 132-2 include an inclined portion 135-1 and a flat portion 136-1, or an inclined portion 135-2 and a flat portion 136-2. The inclined portion 135-1 and the inclined portion 135-2 are formed such that facing distance between the upstream-side upper guide 15 and the inclined portion 135-1 or the inclined portion 135-2 is gradually decreased at a fixed rate from the upstream side to the downstream side in the document carrying direction. In other words, the inclined portion 135-1 and the inclined portion 135-2 are formed so as to be a straight line having an inclination with respect to the slope surface X when viewed from the side surface as illustrated in FIG. 2. In addition, the inclined portion 135-1 and the inclined portion 135-2 are formed such that facing distance between the upstream-side upper guide 15 and the inclined portion 135-1 or the inclined portion 135-2 is not changed in the main scanning direction. The inclined portion 135-1 and the inclined portion 135-2 have a length L1 in the direction of the slope plane X as illustrated in FIG. 3.

The flat portion 136-1 is on a downstream side of the inclined portion 135-1 in the document carrying direction. The flat portion 136-2 is on the downstream side of the inclined portion 135-2 in the document carrying direction. The flat portion 136-1 and the flat portion 136-2 are formed such that facing distance between the upstream-side upper guide 15 and the flat portion 136-1 or the flat portion 136-2 is not changed either in the document carrying direction or the main-scanning direction. The flat portion 136-1 and the flat portion 136-2 have a length L2 in the slope surface X direction as illustrated in FIG. 3. The flat portion 136-1 and the flat portion 136-2 have a height of h1 from the slope surface X. Facing distance between the flat portion 136-1 or the flat portion 136-2 and the upstream-side upper guide 15 is d3. d3 is smaller than d2 by h1. Preferably, d3 is 0.25 mm or more. If d3 is 0.25 mm or more, paper up to 0.25 mm in thickness, such as thick paper up to 209 g/m² can pass.

The back surface convex portion 132-1 has a width w1 in the main-scanning direction. The back surface convex portion 132-2 has a width w2 in the main-scanning direction. An interval between the back surface convex portion 132-1 and the back surface convex portion 132-2 is d1. Preferably, d1 is 182 mm or less. Therefore, when W1 is 297 mm, preferably, w1 and w2 are 57.5 mm or more. 182 mm corresponds to the length of a B5 short side. In other words, if d1 is 182 mm or less, a vertically oriented B5 original document can be placed on the back surface convex portion 132-1 and the back surface convex portion 132-2. In general, an A4 original document seems to be used more frequently than a B5 original document. In addition, the shrinkage amount df tends to be larger for larger original documents. Furthermore, as the width of the back surface convex portion increases, the carrying resistance increases. Therefore, generation of the shift of the read image can be effectively prevented while the increase of the carrying resistance is suppressed by corresponding to a vertically oriented A4 original document, not a vertically oriented B5 original document. Therefore, preferably, d1 is 210 mm or less. In other words, if W1 is 297 mm, more preferably, w1 and w2 are 43.5 mm or more. 210 mm corresponds to the length of an A4 short side. In other words, if d1 is 210 mm or less, the vertically oriented A4 original document can be placed on the back surface convex portion 132-1 and the back surface convex portion 132-2. Since the carrying resistance increases as the width of the back surface convex portion increases, preferably, the width of the back surface convex portion is narrow from the viewpoint of carrying resistance. Therefore, preferably, d1 is 182 mm or more and 210 mm or less. In addition, if W1 is 297 mm, preferably, w1 and w2 are 43.5 mm or more and 56.5 mm or less.

Preferably, the back surface convex portion 132-1 and the back surface convex portion 132-2 are integral with the upstream-side upper guide 15. The reason is that a formation of the back surface convex portion 132-1 and the back surface convex portion 132-2 and the upstream-side upper guide 15 as an integral member is superior in terms of cost or the like than a formation of those as separate members.

As described above, the upstream-side guide 131, the back surface convex portion 132-1, and the back surface convex portion 132-2 form an example of the first guide. In addition, the upstream-side guide 131, the back surface convex portion 132-1, the back surface convex portion 132-2, and the upstream-side upper guide 15 form an example of a sheet carrying guide.

The downstream-side guide 133 is provided so as to guide the carrying of the original document and guide the original document passed over the back surface reading glass 12 to the next carrying destination. The next carrying destination is the paper discharge tray 18, for example. The downstream-side guide 133 faces the downstream-side upper guide 16. The downstream-side guide 133 is an example of a third guide.

The shading roller 134 is provided so as to be rotatable about a direction perpendicular to the paper surface of FIG. 2 as an axis. A surface of the shading roller 134 includes a surface for color correction and a surface having white color as an example. When performing color correction of a back surface optical unit 11, the document carrying device 10 rotates the shading roller 134 so that the surface for color correction of the shading roller 134 faces a side facing the back surface optical unit 11. When reading the image by the back surface optical unit 11, the document carrying device 10 rotates the shading roller 134 so that the surface having white color of the shading roller 134 faces a side facing the back surface optical unit 11 when performing image reading by the back surface optical unit 11. By doing in this way, the back surface optical unit 11 can use the surface having white color of the shading roller 134 as a background when image reading. When the back surface optical unit 11 reads an image, if the surface facing the back surface optical unit 11 is colored, the color may be transparent from the original document, which may interfere with image reading. If the surface facing the back surface optical unit 11 is white, such a problem is unlikely to be generated.

Hereinafter, the surface carrying guide 14 will be described in more detail with reference to FIG. 5 and FIG. 6.

FIG. 5 is a schematic side view illustrating the surface carrying guide 14 and the periphery thereof. FIG. 6 is a schematic cross-sectional view of the surface carrying guide 14 taken along line β-β.

The surface carrying guide 14 includes a surface guide 141, a surface convex portion 142-1, and a surface convex portion 142-2.

The surface guide 141 faces the surface reading glass 22. The surface guide 141 includes a surface Y parallel to the surface reading glass 22. In the description of the surface carrying guide, a direction parallel to the surface Y and perpendicular to the carrying direction is referred to as the main-scanning direction. The carrying direction coincides with the sub-scanning direction. The surface guide 141 has a length of a width W2 in the main-scanning direction. As with the width W1, the width W2 is 297 mm as an example. If the width W2 is 297 mm or more, the original document up to A3 can pass through the carrying path. The width W2 may be a value corresponding to the size of the original document to correspond and is not limited to 297 mm. In addition, a margin may be given to the size of the original document. Facing distance between the surface guide 141 and the surface reading glass 22 is d22.

The surface convex portion 142-1 and the surface convex portion 142-2 are provided such that an interval between the carrying paths formed by the back surface carrying guide 13 and the upstream-side upper guide 15 is narrower on the outer side thereof than on the inner side thereof in the main-scanning direction. A portion of the surface carrying guide 14 closer to the surface reading glass 22 than a surface Y is referred to as a surface convex portion. The surface convex portion 142-1 and the surface convex portion 142-2 include the following shapes as an example.

The surface convex portion 142-1 and the surface convex portion 142-2 include the inclined portion 145-1 and the flat portion 146-1, or the inclined portion 145-2 and the flat portion 146-2. The surface convex portion 142-1 and the surface convex portion 142-2 include shapes similar to those of the back surface convex portion 132-1 and the back surface convex portion 132-2. The flat portion 146-1 and the flat portion 146-2 have a height of h21 from surface Y. Facing distance between the flat portion 146-1 or the flat portion 146-2 and the upstream-side upper guide 15 is d23. d23 is smaller value than that of d22 by h2.

The surface convex portion 142-1 has a length of a width w21 in the main-scanning direction. The surface convex portion 142-2 has a length of a width w22 in the main-scanning direction. An interval between the surface convex portion 142-1 and the surface convex portion 142-2 is d21. As with d1, d21 is preferably 182 mm or less, more preferably 210 mm or less, and most preferably 210 mm. As with w1 and w2, w21 and w22 are preferably 57.5 mm or more, more preferably 43.5 mm or more, and most preferably 43.5 mm.

As described above, the surface carrying guide 14 is an example of the first guide. Therefore, the housing 19 is an example of the second guide. In addition, the surface carrying guide 14 and the housing 19 form an example of a sheet carrying guide.

In the image reading system 1 of the first embodiment, an outside of the carrying path is narrower than an inside thereof. Accordingly, increase in carrying resistance can be further suppressed by the image reading system 1 than a case where the entire from the outside to the inside thereof is narrowed while suppressing the floating of the original document and reducing the shift of the read image.

In addition, the image reading system 1 of the first embodiment includes a back surface convex portion on the upstream side of the back surface reading glass 12. Since the back surface convex portion is positioned upstream of the back surface reading glass 12, even when an image is read from the upper side of the original document, the original document is likely to be in contact with the back surface reading glass 12 against the force of gravity and generation of the floating thereof can be suppressed compared to the related art.

In addition, according to the image reading system 1 of the first embodiment, the carrying path formed by the upstream-side guide 131, the back surface convex portion 132-1, the back surface convex portion 132-2 and the upstream-side upper guide 15 is obliquely oriented with respect to the back surface reading glass 12. Accordingly, even when reading an image from the upper side of the original document, the original document is likely to be in contact with the back surface reading glass 12 against the force of gravity, generation of the floating thereof can be suppressed compared to the related art.

In addition, according to the image reading system 1 of the first embodiment, the back surface convex portion 132-1 and the back surface convex portion 132-2 include the inclined portion 135-1 or the inclined portion 135-2. As compared with the case where the back surface convex portion 132-1 and the back surface convex portion 132-2 do not include the inclined portion, it is considered that the original document hardly catches on the back surface convex portion 132-1 or the back surface convex portion 132-2 and generation of clogging or the like can be suppressed.

### Second Embodiment

In the second embodiment, the image reading system includes a back surface convex portion 132b instead of the back surface convex portion 132-1 and the back surface convex portion 132-2 of the first embodiment. Since the other portions are the same as those in the first embodiment, the description thereof is omitted.

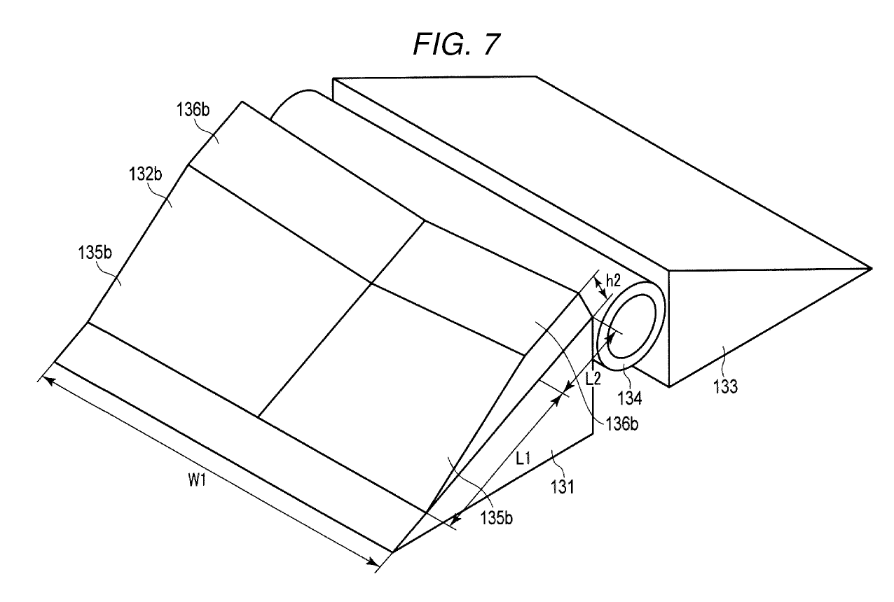

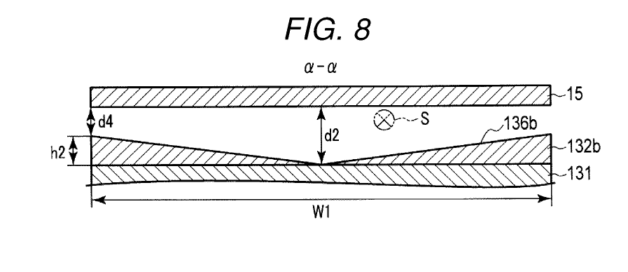

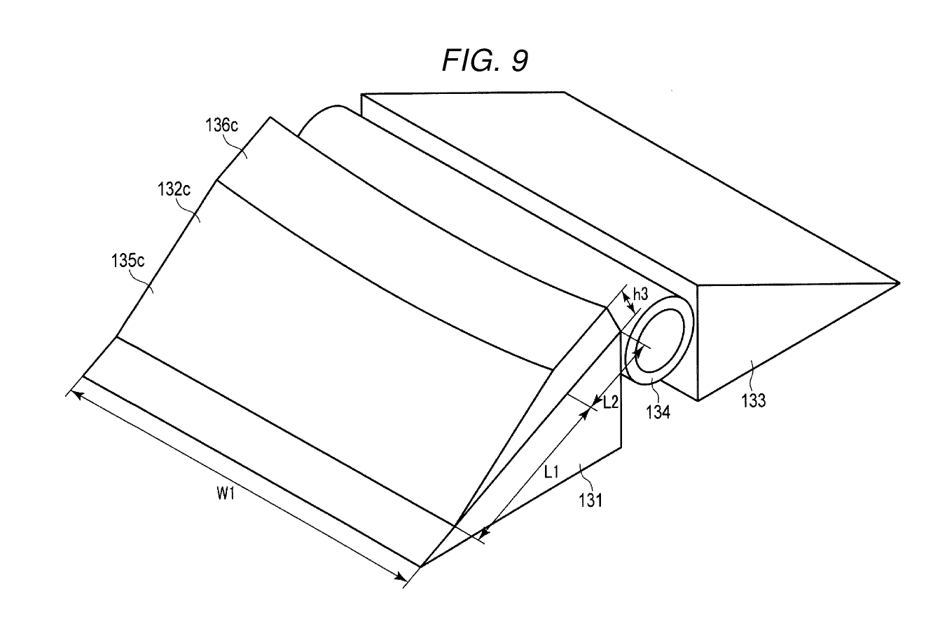

The back surface convex portion 132b according to the second embodiment will be described with reference to FIG. 7 and FIG. 8. FIG. 7 is a perspective view illustrating a back surface carrying guide according to the second embodiment. FIG. 8 is a schematic cross-sectional view taken along line α-α illustrating the back surface carrying guide and the periphery thereof according to the second embodiment. FIG. 7 is a view corresponding to FIG. 3 in the first embodiment. In addition, FIG. 8 is a view corresponding to FIG. 4 in the first embodiment. Since the side view is similar to that of the first embodiment, the description thereof is omitted.

The back surface convex portion 132b includes an inclined portion 135b and a flat portion 136b. The inclined portion 135b is formed so that facing distance between the upstream-side upper guide 15 and the inclined portion 135b is decreased as it goes from the upstream side to the downstream side in the document carrying direction. In other words, when viewed from the side surface, the inclined portion 135b is formed to be a straight line inclined with respect to the slope surface X similarly to the inclined portion 135-1 and the inclined portion 135-2. In addition, the inclined portion 135b is formed such that facing distance between the upstream-side upper guide 15 and the inclined portion 135b is decreased at a fixed rate from the center to the outside (both ends of right end and left end) in the main-scanning direction. In other words, the inclined portion 135b includes an inclination with respect to the slope surface X in the main-scanning direction.

The flat portion 136b is on the downstream side of the inclined portion 135b in the document carrying direction. The flat portion 136b is formed so that facing distance between the upstream-side upper guide 15 and the flat portion 136b is not changed in the document carrying direction. However, the flat portion 136b is formed such that the facing distance between the upstream-side upper guide 15 and the flat portion 136b is decreased at a fixed rate from the center to the outside in the main-scanning direction. In other words, the flat portion 136b includes an inclination with respect to the slope surface X in the main-scanning direction. As illustrated in FIG. 8, the flat portion 136b is formed so that the α-α cross section has a V shape. The right end and the left end of the flat portion 136b have a height of h2 from the slope surface X. Facing distance between the right end and the left end of the flat portion 136b and the upstream-side upper guide 15 is d4. d4 is smaller value than that of d2 by h2.

According to the image reading system of the second embodiment, the carrying path gradually narrows from the inside to the outside thereof. Accordingly, the image reading system can suppress floating even for small size original documents. In addition, the image reading system can further suppress the floating of large size original documents.

As described above, the upstream-side guide 131 and the back surface convex portion 132b form an example of the first guide. In addition, the upstream-side guide 131, the back surface convex portion 132b, and the upstream-side upper guide 15 form an example of the sheet carrying guide.

### Third Embodiment

In a third embodiment, an image reading system includes a back surface convex portion 132c instead of the back surface convex portion 132b of the second embodiment. Since the other portions are the same as those of the second embodiment, the description thereof is omitted.

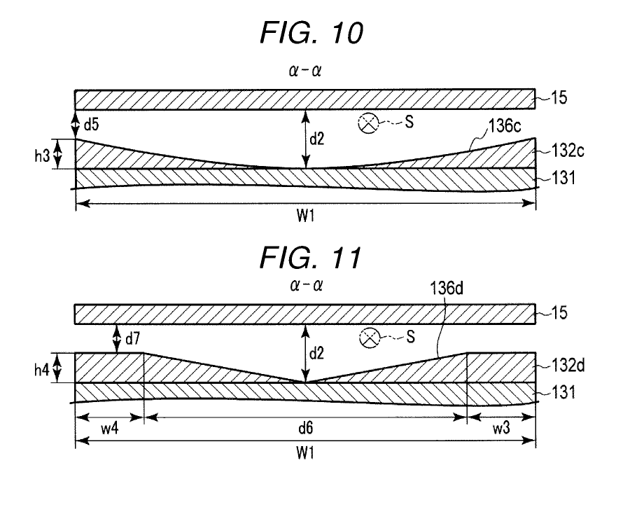

The back surface convex portion 132c according to the third embodiment will be described with reference to FIG. 9 and FIG. 10. FIG. 9 is a perspective view illustrating a back surface carrying guide according to the third embodiment. FIG. 10 is a schematic cross-sectional view taken along line α-α illustrating the back surface carrying guide and the periphery thereof according to the second embodiment. FIG. 9 is a view corresponding to FIG. 7 in the second embodiment. In addition, FIG. 10 is a view corresponding to FIG. 8 in the second embodiment. Since the side view is similar to those of the first embodiment and the second embodiment, it is omitted.

The back surface convex portion 132c includes an inclined portion 135c and a flat portion 136c. The inclined portion 135c is formed such that the facing distance between the upstream-side upper guide 15 and the inclined portion 135c is decreased as it goes from the upstream side to the downstream side in the document carrying direction. In addition, the inclined portion 135c is formed such that the facing distance between the upstream-side upper guide 15 and the inclined portion 135c is decreased from the center to the outside thereof in the main-scanning direction. In other words, the inclined portion 135c is formed so as to be a straight line inclined with respect to the slope surface X similarly to the inclined portion 135b when viewed from the side surface. The inclined portion 135c is formed such that the ratio at which the facing distance is decreased increases as it goes outside from the center thereof. In other words, the inclined portion 135c is formed such that the inclination with respect to the slope surface X in the main-scanning direction becomes tighter as it goes outside from the center thereof.

The flat portion 136c is on the downstream side of the inclined portion 135c in the document carrying direction. The flat portion 136c is formed so that the facing distance between the upstream-side upper guide 15 and the flat portion 136c is not changed in the document carrying direction. However, the flat portion 136c is formed such that the facing distance between the upstream-side upper guide 15 and the flat portion 136c is decreased from the center to the right end or the left end in the main-scanning direction. The flat portion 136c is formed so that the ratio at which the facing distance is decreased increases as it goes outside from the center thereof. In other words, the flat portion 136c is formed such that the inclination with respect to the slope surface X in the main-scanning direction becomes tighter as it goes outside from the center thereof. As illustrated in FIG. 8, the flat portion 136c is formed so that the α-α cross section has a curved shape as with the bottom portion of the U shape. The curve is a clothoid curve, a cycloid curve, a circular arc, an elliptical arc, a hyperbolic curve, a parabola or a tertiary parabola, or a combination thereof, for example. The right end and the left end of the flat portion 136c have a height of h3 from the slope surface X. The facing distance between the right end and the left end of the flat portion 136c and the upstream-side upper guide 15 is d4. d4 is smaller value than that of d2 by h3.

According to the image reading system of the third embodiment, the carrying path narrows from the inside to the outside. Furthermore, the carrying path narrows sharply as it goes outside. Accordingly, the image reading system can suppress an increase in the carrying resistance as compared to the second embodiment.

As described above, the upstream-side guide 131 and the back surface convex portion 132c form an example of a first guide. In addition, the upstream-side guide 131, the back surface convex portion 132c, and the upstream-side upper guide 15 form an example of a sheet carrying guide.

The above embodiment can also be modified as follows.

FIG. 11 is a schematic cross-sectional view taken along line α-α illustrating the back surface carrying guide and the periphery thereof according to the modification example of the embodiment. The back surface convex portion may be formed to include α-α cross section as illustrated in FIG. 11. In other words, the back surface convex portion 132d is formed such that the facing distance between the upstream-side upper guide 15 and the back surface convex portion 132d is decreased at a fixed rate from the center to the middle of the outside thereof in the main-scanning direction. Accordingly, the cross-sectional shape of the portion from the center to the middle has a V shape. The width of this portion in the main-scanning direction has a length of d6. The back surface convex portion 132d is formed such that the facing distance between the upstream-side upper guide 15 and the back surface convex portion 132d is not changed from the middle to the right end or the left end thereof. The width of this portion in the main-scanning direction has a length of w3 and w4 on the right side and the left side respectively. As with d1, d6 is preferably 182 mm or less, more preferably 210 mm or less, and most preferably 210 mm. As with w1 and w2, w3 and w4 are preferably 57.5 mm or more, and more preferably 43.5 mm or more, and most preferably 43.5 mm.

In addition, the back surface convex portion 132d may be formed so that the facing distance between the upstream-side upper guide 15 and the back surface convex portion 132d is decreased so that the inclination becomes tighter as it goes from the center to the middle of the outside in the main-scanning direction. In other words, the cross-sectional shape of the portion from the center to the middle becomes a curve as with the bottom portion of the U shape. The curve is a clothoid curve, a cycloid curve, a circular arc, an elliptic arc, a hyperbolic curve, a parabola or a tertiary parabola, or a combination thereof, for example.

The upstream-side guide 131 and the back surface convex portion 132d form an example of a first guide. In addition, the upstream-side guide 131, the back surface convex portion 132d, and the upstream-side upper guide 15 form an example of a sheet carrying guide.

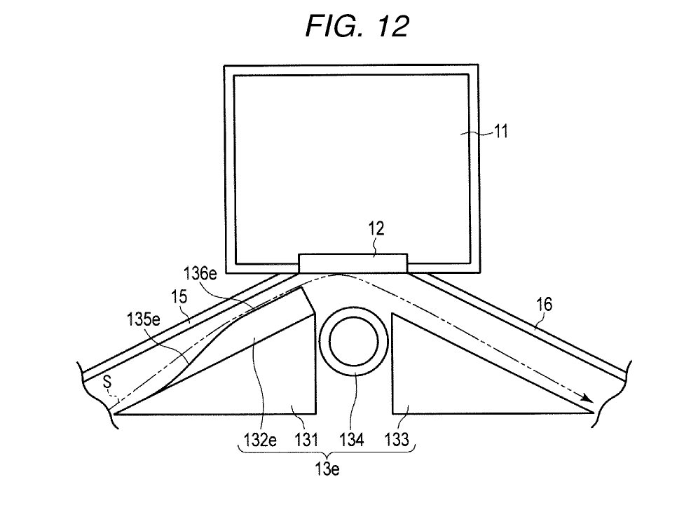

FIG. 12 is a schematic side view illustrating a back surface carrying guide 13e and a periphery thereof according to a modification example of the embodiment. As illustrated in FIG. 12, the back surface convex portion may be formed so that the upstream-side guide 131 and the inclined portion are smoothly connected with each other when viewed from the side surface. In other words, as an example, the back surface convex portion 132e includes an inclined portion 135e and a flat portion 136e. The inclined portion 135e is formed such that the facing distance between the upstream-side upper guide 15 and the inclined portion 135e is decreased as it goes from the upstream side to the downstream side in the document carrying direction. As illustrated in FIG. 12, the inclined portion 135e is formed to have a curved shape so as to smoothly connect the upstream-side guide 131 with the inclined portion 135e. The curve is a clothoid curve, a cycloid curve, a circular arc, an elliptic arc, a hyperbolic curve, a parabola or a tertiary parabola, or a combination thereof, for example. In other words, the inclined portion 135e includes a section in which the inclination with respect to the X slope surface in the carrying direction increases as it goes from the upstream side to the downstream side in the carrying direction. For example, the section starts from the most downstream side of the inclined portion 135e. As described above, it is considered that the original document hardly catches on the back surface convex portion 132e and generation of clogging or the like can be suppressed since the upstream-side guide 131 and the inclined portion 135e are smoothly connected with each other.

Further, as illustrated in FIG. 12, the back surface convex portion may be formed so that the inclined portion and the flat portion are smoothly connected with each other when viewed from the side surface. In other words, as an example, the inclined portion 135e is formed to have a curved shape so as to smoothly connect the inclined portion 135e with the flat portion 136e as illustrated in FIG. 12. The curve is a clothoid curve, a cycloid curve, a circular arc, an elliptic arc, a hyperbolic curve, a parabola or a tertiary parabola, or a combination thereof, for example. In other words, the inclined portion 135e includes a section in which the inclination with respect to the X slope surface increases in the carrying direction as it goes from the downstream to the upstream in the carrying direction. For example, the section starts from the most upstream side of the inclined portion 135e. As described above, since the inclined portion 135e and the flat portion 136e are smoothly connected with each other, it is considered that the original document hardly catches on the back surface convex portion 132e, and generation of clogging of the original document or the like can be suppressed.

The upstream-side guide 131 and the back surface convex portion 132e form an example of a first guide. In addition, the upstream-side guide 131, the back surface convex portion 132e, and the upstream-side upper guide 15 form an example of a sheet carrying guide.

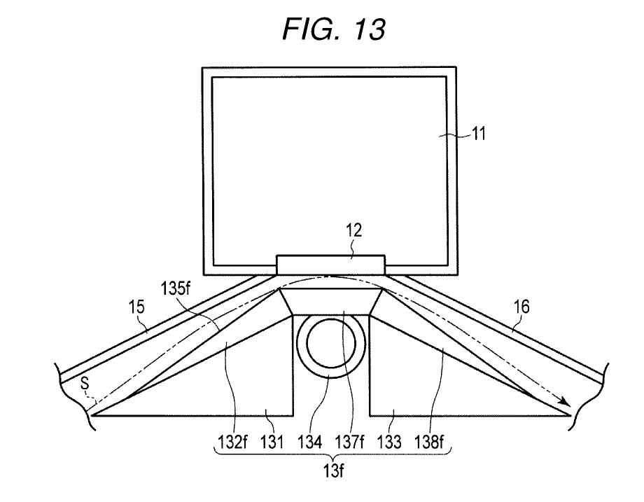

FIG. 13 is a schematic side view illustrating the back surface carrying guide 13f and the periphery thereof according to a modification example of the embodiment. As illustrated in FIG. 13, the back surface convex portion may not include a flat portion. In other words, as an example, although the back surface convex portion 132f includes the inclined portion 135f in which the facing distance between the upstream-side upper guide 15 and the back surface convex portion 132f is changed in the document carrying direction, the back surface convex portion 132f is formed so that a portion where the facing distance between the upstream-side upper guide 15 and the back surface convex portion 132f is not changed does not include in the document carrying direction.

As illustrated in FIG. 13, the back surface carrying guide may also be formed in a portion where the back surface convex portion faces the back surface reading glass 12. In other words, as an example, the back surface carrying guide 13f includes a back surface convex portion 137f in addition to the back surface convex portion 132f. The back surface convex portion 137f is provided so that the interval between the carrying paths formed by the back surface carrying guide 13 and the back surface reading glass 12 is narrower on the outside than on the inside in the main-scanning direction.

As illustrated in FIG. 13, in the back surface carrying guide, the back surface convex portion may be also formed on the downstream-side guide 133 as with the upstream-side guide 131. In other words, as an example, the back surface carrying guide 13f includes a back surface convex portion 138f in addition to the back surface convex portion 132f. The back surface convex portion 138f is provided so that the interval between the carrying paths formed by the back surface carrying guide 13 and the downstream-side upper guide 16 is narrower on the outside than on the inside in the main-scanning direction. The back surface convex portion 138f is a shape obtained by inverting the back surface convex portion 132f, for example.

The upstream-side guide 131 and the back surface convex portion 132f form an example of a first guide. In addition, the upstream-side guide 131, the back surface convex portion 132f, and the upstream-side upper guide 15 form an example of a sheet carrying guide.

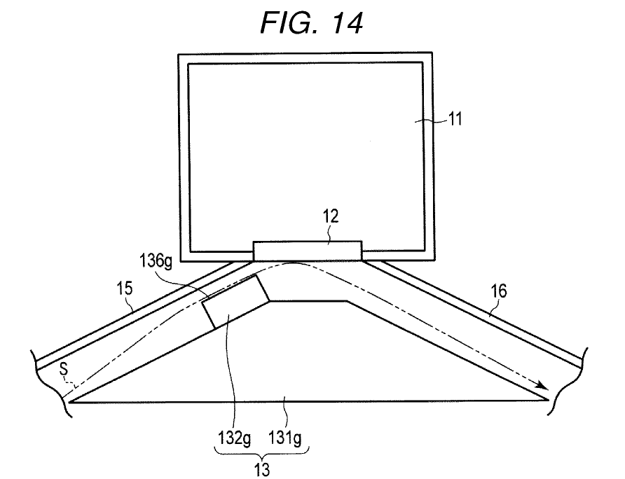

FIG. 14 is a schematic side view illustrating the back surface carrying guide 13g and the periphery thereof according to a modification example of the embodiment. As illustrated in FIG. 14, the back surface convex portion may not include the inclined portion. In other words, as an example, although the back surface convex portion 132f includes the flat portion 136g in which the facing distance between the upstream-side upper guide 15 and the back surface convex portion 132f is not changed in the document carrying direction, the back surface convex portion 132f is formed in order not to include an inclined portion where the facing distance between the upstream-side upper guide 15 and the back surface convex portion 132f change in the document carrying direction.

As illustrated in FIG. 14, the back surface carrying guide may not include the shading roller 134.

Further, as illustrated in FIG. 14, the upstream-side guide 131 and the downstream-side guide 133 may be connected with each other on the back surface carrying guide.

A guide 131g and the back surface convex portion 132g form an example of a first guide. In addition, the guide 131g, the back surface convex portion 132g, and the upstream-side upper guide 15 form an example of a sheet carrying guide.

In the embodiment described above, the back surface carrying guide is used when reading an image from above the original document. However, since the back side carrying guide is used in a state where the orientation of the back side carrying guide is changed, the back surface carrying guide may be used when reading an image from below the original document or from the side of the original document.

The angle θ1 may be 0°. The angle θ2 may be 0°.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A sheet carrying guide, comprising:
a first guide configured to guide a sheet carried in a sub-scanning direction orthogonal to a main-scanning direction corresponding to a reading unit configured to read an image; and
a second guide configured to face the first guide and guide carrying of the sheet,
wherein facing distance between the first guide and the second guide in both end portions of the main-scanning direction is narrower than facing distance between the first guide and the second guide in center portion thereof in the main-scanning direction, the first guide and the second guide are separate from each other at both end portions of the main-scanning direction.

2. The guide according to claim 1,
wherein the first guide includes convex portions at both end portions in the main-scanning direction in a facing side of the second guide.

3. The guide according to claim 1,
wherein the first guide is inclined from the both end portions in the main-scanning direction to the center portion in the main-scanning direction in the facing side of the second guide.

4. The guide according to claim 1,
wherein the first guide and the second guide both guide carrying of the sheet toward a reading surface of the reading unit.

5. The guide according to claim 1,
wherein the first guide and the second guide both guide carrying of the sheet from an upstream to a downstream toward a reading surface of the reading unit.
